(19) United States
(12) Patent Application Publication
(10) Pub. No.: US 2005/0036828 A1
(43) Pub. Date: Feb. 17, 2005

(54) Method of releasing an attachment

(76) Inventors: Pia Tanskanen, Helsinki (FI); Matti Ryynanen, Helsinki (FI)

Correspondence Address: Crawford Maunu, Suite 390, 1270 NorthLand Drive, Mendota Heights, MN, 55120, US

(21) Appl. No.: 10/496,698

(22) PCT Filed: Nov. 20, 2002
(86) PCT No.: PCT/FI02/00931

(30) Foreign Application Priority Data
Dec. 3, 2001 (FI) 20012371

(51) Int. Cl. F16B 4/00

(52) U.S. Cl. 403/28

(57) ABSTRACT

The invention relates to a product comprising at least two parts (1, 2) attached to each other by at least one attachment means. In order to make automated disassembly of the product possible, said at least one attachment means (3 to 5) includes an element (5) made of an MSM material, which is shaped in a first shape allowing said at least one attachment means (3 to 5) to attach said parts (1, 2) to each other, and which is responsive to a magnetic field for entering a shape transition resulting in a second shape, whereby the attachment between said parts achieved by said at least one attachment means (3 to 5) is released.

### BACKGROUND OF THE INVENTION

1. Field of the Invention

This invention relates to a solution which makes it possible to release an attachment between parts attached to each other. In the following the invention will be explained, by way of example, in more detail, mainly with reference to the disassembly of products whose parts shall be recycled. It is, however, important to realize that the present invention can be utilized also for other purposes.

2. Description of the Prior Art

Legislation regarding the recycling of different materials has lead to a situation where more and more products need to be disassembled in order to make it possible to recycle the different parts of the products. For instance the following components must be removed from a product for recycling: Printed Wiring Boards (PWB), Liquid Crystal Displays (LCD), electrolytic capacitors, batteries, gas discharge lamps, Cathode Ray Tubes (CRT), and parts containing beryllium oxide or mercury.

To manually disassemble a product is very slow and expensive. An alternative solution is to shred the product entirely. This is, however, not a good solution because then the different toxic components inside the product mix with each other, which is not good if efficient recycling is the goal. Thus there exists a need for an efficient and cheap solution which makes it possible to automatically disassemble products.

### SUMMARY OF THE INVENTION

An object of the present invention is to solve the above mentioned drawback and to provide an efficient and cheap solution for automatic handling of parts of a product during different phases of the lifecycle of the product.

Another object of the present invention is to provide a solution which makes it possible to automatically disassemble products of various kinds without a need to create product-specific disassembly lines designed for the disassembly of a single product model alone.

A still further object is to achieve a solution for the disassembly of products where the disassembly of a single product is very fast.

The above mentioned and other objects of the present invention are achieved with a method according to independent claims 1 and 7 and with a product according to independent claim 11.

The invention is based on the idea of utilizing an MSM element (Magnetic Shape Memory) in attachment means used to attach parts to each other. An MSM material is a material which can be controlled by a magnetic field to perform a shape transition from a first shape to a second shape. According to the present invention, the MSM element is included in the attachment means before the parts are attached to each other. At this stage the MSM element has a first shape allowing the attachment means to attach the parts to each other. The first shape can be given to the MSM element in connection with the assembly of the product, in which case the forces involved in an snap-attachment, for instance, will reshape the MSM element into the first shape allowing the attachment means to attach to each other.

When it is time to disassemble the product, then the attachment means of the product are exposed to a magnetic field. This magnetic field triggers a shape transition of the MSM element, resulting in a second shape in which the MSM element allows the attachment means to release the attachment between the parts. The MSM elements used in the present invention can consist of elongated elements, for instance, whose length changes due to the magnetic field. In this case it is possible to decrease or increase the length of the MSM element depending on the direction of the magnetic field and the first shape given to the MSM element.

The most significant advantages of the present invention are that the attachment between the parts is very easy to release by exposing the attachment means to a magnetic field, the release of the attachment can be assured not to occur too soon (when the product is still in use), as it is possible to select for the MSM element a material whose shape transition requires a magnetic field with a field strength substantially stronger than the field strengths of magnetic fields that normally occur in the environment where the product is used; and that the release between the parts occurs very fast (in a few milliseconds) after the attachment means have been exposed to the appropriate magnetic field.

It is important to realize that MSM materials are different from those known as shape memory alloys. Shape memory alloys can return to an original shape when they are heated up to a predetermined temperature. Shape memory alloys have, however, the drawback that their reaction time is rather slow, which means that it takes time to get the temperature to rise to a suitable level in order to achieve the desired shape transition. MSM materials, on the other hand react very fast when the temperature is right and the material is exposed to an appropriate magnetic field. This also means that it is possible to achieve the shape transition of a MSM material exactly at the desired moment.

In a first preferred embodiment of the present invention the MSM element is manufactured such that it will enter a shape transition phase in a magnetic field only if the temperature of the material has been cooled down to a predetermined temperature range. This embodiment is very advantageous as the risk of accidentally triggering a shape transition of the MSM element during the ordinary use of the product can be even further minimized. In this embodiment two different conditions must be met in order for the shape transition to occur: 1) the magnetic field must be strong enough, and 2) the temperature of the attachment means must be low enough.

The preferred embodiments of the present method and product appear from the attached independent claims 2 to 6, 8 to 10 and 13 to 14.

### BRIEF DESCRIPTION OF THE DRAWINGS

In the following the present invention will be described in closer detail by way of example and with reference to the attached drawings, in which

FIG. 1 is a flow diagram of a first preferred embodiment of the method of the present invention,

FIG. 2 is a flow diagram of a second preferred embodiment of the method of the present invention, and

FIGS. 3, 4a, 4b, 5 and 6a to 6c show preferred embodiments of products according to the present invention.

### DESCRIPTION OF THE PREFERRED EMBODIMENTS

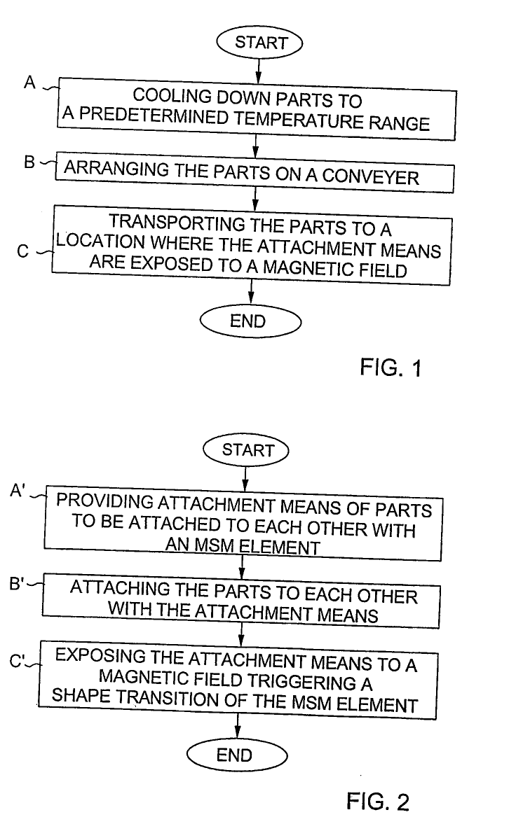

FIG. 1 is a flow diagram of a first preferred embodiment of the method of the present invention. The method of FIG. 1 can be used, for instance, for automated disassembly of mobile phones when the components of the mobile phones are to be recycled.

It is assumed in FIG. 1 that the attachment means used to attach parts to each other are provided with an MSM element. In block A the attached parts are cooled down to a predetermined temperature range dependent on the selected MSM element. In FIG. 1K is assumed, by way of example, that the MSM element is responsive to a magnetic field such that its shape changes only if the temperature of the element has been lowered to a predetermined temperature range.

The temperature range where a magnetic field can trigger the shape transition of the MSM element can be adjusted during the manufacture of the MSM element. The temperature range is effected by the consistence of the material, the manufacturing method, and heat treatment carried out after the actual manufacturing step. MSM materials (Magnetic Shape Memory) exhibit an austenitic crystal structure above a characteristic phase transformation temperature and a martensitic twinned crystal structure below the phase transition temperature. Exampled of MSM materials whose transition from one shape to another can be triggered by a magnetic field are NiMaGa and Ni2MaGa alloys. These materials are available for instance from AdaptaMat Ltd., Yrityspiha 5, FIN-00390 Helsinki, Finland. MSM materials and their properties are also described for instance in the U.S. Pat. No. 5,958,154 (Inventors: Robert O'Handley and Kari Ullakko), which incorporated herein by reference. Three conditions have to be fulfilled in order to achieve the shape transition of an MSM element:
1) The magnetic field should have an effect on the ferromagnetic range. This means that the temperature should be below the Curie temperature. The right temperature depends on the material used.
2) The structure of the crystal should be twinned and the twinning energy should be low enough to enable stiff magnetic material in the crystal to turn the twinning from one position to another. A martensitic structure is twinned and an austenitic crystal is not twinned. The structure changes between martensitic and austenitic due to temperature changes. The material is martensitic below a specific temperature. This phase transition temperature can be adjusted by changing the consistence and the manufacturing method.
3) A martensitic crystal has several sub-structures. Only a few of these work in MSM elements. A significant MSM effect occurs for NiMaGa when the structure has five layers. The temperature range where such a structure occurs can be adjusted when the consistence and the manufacturing method is suitable. Thus the material can be manufactured such that this five-layer structure occurs only within a predetermined temperature range.

In a preferred embodiment of the invention the temperature range (where the shape transition of an MSM element can be triggered with a magnetic field) has been adjusted such that it is substantially below ordinary room temperature. This allows to avoid a situation where a shape transition would be accidentally triggered by a magnetic field during normal use of the product (such as a mobile phone).

It is also possible to use an MSM element which does not require any cooling down as the MSM element is responsive to a magnetic field already at an ordinary room temperature. In this case the method step of block A is not necessary.

In block B the products containing parts to be released from each other are arranged onto a conveyer. The conveyer can be equipped with means which turn the products into a specific, predetermined position. Such a solution makes it possible to ensure that the products will be in a predetermined position when they arrive at the location of a magnetic field. Alternatively, it is also possible to use, for instance, a conveyer where the products are positioned randomly. Such a conveyer can circulate the same products several times through the magnetic field and for instance include means which continuously change the position of the products. Each product thus eventually enters the magnetic field in a suitable position and the MSM element in the attachment means of this product enters a shape transition releasing the attachment between the parts of the product. An alternative approach is to create a magnetic field whose direction changes. Such a changing magnetic field can be accomplished by using one or several electromagnets, for instance. In that case it is not necessary to change the position of the product, instead, the variation in the direction of the magnetic field ensures that the magnetic field will eventually have a direction which triggers the shape transition of the MSM element.

In block C the parts are exposed to the magnetic field. A magnetic field suitable for triggering a shape transition might be created for instance by a permanent magnet. One possibility is that the products are dropped from the conveyer through a gap where the magnetic field is located. Those products which are in a correct position will then be disassembled due to the shape transition of their MSM elements.

When the attachment between the parts has been released, further steps can be taken in order to sort the different components of the products in a suitable way in order to achieve efficient recycling. There are several alternative solutions for carrying out this. One alternative is that components of a similar type are manually collected from the conveyer. Another alternative is that the components are automatically separated from each other by transporting the components with a conveyer capable of sorting the components based on their magnetic properties or size, for instance.

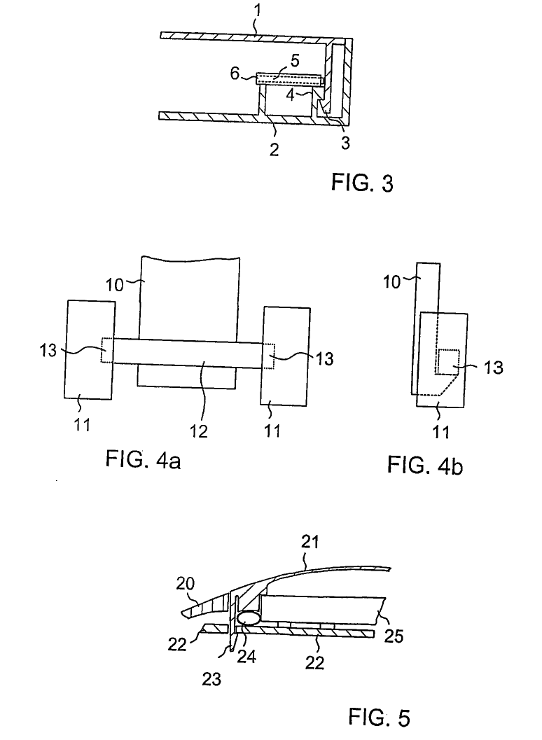

FIG. 2 is a flow diagram of a second preferred embodiment of the method of the present invention. The method of FIG. 2 can be used for assembling and disassembling products, such as mobile phones.

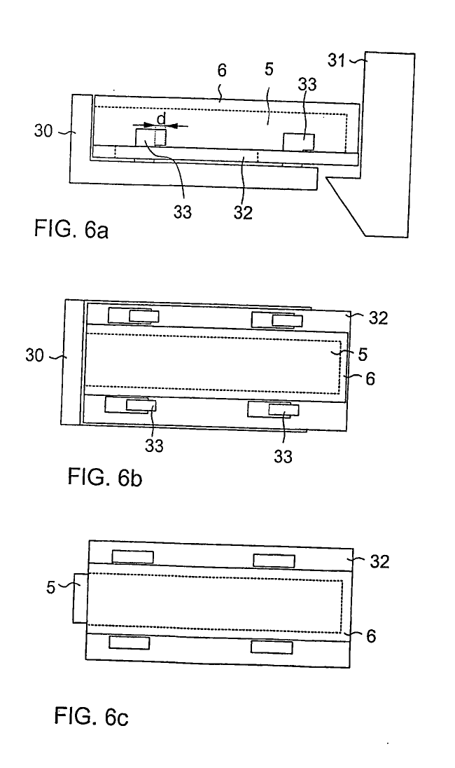

In block A′ the attachment means of the parts are provided with a MSM element. Examples of suitable MSM elements and attachment means are shown for instance in FIGS. 3 to 6c.

In block B′ the parts are attached to each other with the attachment means. At this stage the MSM elements used in the parts have been given a first shape which allows the attachment of the parts.

In block C′ the attachment means are exposed to a magnetic field which releases the attachment between the components as described in connection with block C of FIG. 1.

FIGS. 3 to 6c show preferred embodiments of products according to the present invention.

FIG. 3 shows a partial cross-section of two parts 1 and 2 attached to each other. The parts 1 and 2 might be for instance plastic cover parts of a mobile phone. Part 1 has been provided with a hook 3 that is shaped to grip a support 4 in part 2. This snap attachment between the resilient hook 3 and the support 4 makes it possible to assemble the product simply by pressing together parts 1 and 2.

In order to facilitate automated disassembly of the product in FIG. 3, the attachment means have also been provided with an MSM element 5. The MSM element 5 is shaped as an elongated part arranged inside a tube 6. The end of the elongated element located to the left in FIG. 3 is attached to the tube 6. The other end of the element is free.

When the attachment means of the parts shown in FIG. 3 are exposed to a magnetic field, the MSM element 5 enters a shape transition resulting in a new shape for the MSM element 5. In this second shape the length of the MSM element has increased. As the tube 6 is attached to part 2 and the left end of the MSM element is attached to the tube 6, the increased length of the MSM element 5 will result in a situation where the MSM element 5 pushes the resilient hook 3 to the right in FIG. 3, so that the hook bends and looses the grip of support 4. Parts 1 and 2 are thereby released from each other and part 1 can be detached from part 2. It is also possible to insert a helical spring (not shown), for instance, between parts 1 and 2 when the product is assembled. The helical spring will push apart parts 1 and 2 when the parts have been released from each other.

Available MSM materials based on NiMnGa or Ni2MaGa alloys, for instance, can be used to create elongated elements whose length increase is around 5% when the elements are exposed to a magnetic field in an appropriate temperature range. Such an MSM element requires a field strength of around 0.8 T in order to achieve a shape transition.

FIGS. 4a and 4b show a second preferred embodiment of a product according to the present invention. In FIGS. 4a and 4b only the attachment means attaching the parts to each other are shown. FIG. 4a shows a part with a hook 10 attached to a second part comprising two supports 11. FIG. 4b shows a side-view of the parts in FIG. 4a.

In FIGS. 4a and 4b the hook 10 is attached to an elongated MSM element 12. The opposite ends 13 of the MSM element 12 protrude into cavities located in the supports 11. Thus the hook and the MSM element 12 are attached to the second part via the supports 11.

The MSM element 12 of FIGS. 4a and 4b has been given a first shape shown in the Figures. When a shape transition is triggered by exposing the MSM element to a magnetic field while the temperature is within an appropriate range, the length of the MSM element 12 decreases. After the shape transition the MSM element is no longer long enough to protrude into both supports 11. Thus the MSM element 12 and the hook 10 are released from the supports 11.

FIG. 5 shows a third preferred embodiment of a product according to the present invention. FIG. 5 shows a body 20 of a mobile phone and a cover 21 arranged over the LCD display 25 of the mobile phone.

The display 25 and the cover 21 (glass) are attached to a circuit board 22. The attachment means attaching the cover 21 to the circuit board 22 includes a plastic hook 23 gripping the back of the circuit board 22 and an MSM element 24 shaped like an elliptic tube. The MSM element is arranged in a space between the cover 21 and the circuit board 22.

As soon as the MSM element 24 is exposed to an appropriate magnetic field under appropriate conditions, the MSM element 24 enters a shape transition resulting in the shape of a circular tube. As a result of this shape transition the space between the cover 21 and the circuit board 22 is no longer big enough for the MSM element. A force will therefore be directed towards the cover 21 and the circuit board 22 and the result of this force is that the hook 23 looses its grip of the circuit board, or, alternatively, either the hook or the circuit board breaks such that the cover 21 and the circuit board are released from each other.

FIGS. 6a to 6c show a fourth preferred embodiment of a product according to the present invention. In FIGS. 6a to 6c only the attachment means attaching the parts to each other are shown. FIG. 6a shows a part with a hook 31 attached to a second part 30 via a bottom plate 32.

The second part 30 comprises hooks 33 shaped to protrude through holes made in the bottom plate 32. The hooks 33 will keep the bottom plate 33 attached to the part 30 and at the same time also the hook 31 attached to the part 30 as long as the bottom plate is kept in the position shown in FIGS. 6a and 6b.

A tube 6 with an MSM element 5 inside it (similar as shown in Figure 3) is attached to the bottom plate 32. When attachment between the parts 30 and 31 should be released, then the MSM element is (at a suitable temperature) exposed to a magnetic field with a suitable direction. The MSM element will then enter a shape transition such that the length of the MSM element increases, and the end shown to the left in FIG. 6c will protrude from the tube 6. This left end will then push the entire tube 6 and the bottom plate 32 attached to the tube to the right (in FIG. 6c). The result is that the hooks 33 will no longer grip the bottom plate and thus the bottom plate 32 and the hook 31 are released from the part 30.

An advantage with the embodiment of FIGS. 6a to 6c is that a relatively little increase of the length of the MSM element 5 is needed in order to release parts 31 and 30 from each other. This is possible when the hooks 33 are dimensioned such that the distance d is short. The hooks 33 and the bottom plate can be glued to each other in order to ensure a sufficient attachment between the hooks 33 and the bottom plate 32. Then the shape transition of the MSM element occurs, then the movement of the bottom plate will brake the glue and release the parts from each other.

It should be observed that FIGS. 3 to 6c show by way of example, only a few alternatives on how an MSM element could be included in attachment means attaching parts to each other. In practice it may be advantageous to include several different types of attachment means and MSM elements in a single product, If the goal in such a case is to release all attachments in the product at once by using a single magnetic field, this should be taken into account in the design of the product such that all the MSM elements will enter their shape transition when exposed to a magnetic field from the same direction, and the required temperature range for the shape transition is the same for all MSM elements.

In some cases it may be advantageous to create a product where only one or a few parts attached to each other are released in a first magnetic field and later on other parts attached to each other are released with a second field. This makes it possible to release only plastic parts, for instance, with the first magnetic field and only components unsuitable for recycling with a second field, for instance, and so on. This kind of phased disassembly of a product can be achieved by using different kinds of MSM elements having different temperature ranges for shape transition (for instance two different groups of MSM elements responsive to magnetic fields within different temperature ranges), or by using MSM elements responsive to differently directed magnetic fields (for instance a first group of MSM elements enters a shape transition when the magnetic field is directed in a first direction through the product and a second group of MSM elements enters a shape transition when the magnetic field is directed in a second direction through the product). Such a phased disassembly makes it easier to sort the different components of a product because all the components of the product are not released at once.

It is to be understood that the above description and the accompanying figures are only intended to illustrate the present invention. It will be obvious to those skilled in the art that the invention can be varied and modified also in other ways without departing from the scope and spirit of the invention disclosed in the attached claims.

1. A method of releasing an attachment between parts attached to each other by at least one attachment means, comprising
exposing said at least one attachment means to a magnetic field, which triggers a Magnetic Shape Memory (MSM) element included in said at least one attachment means to a shape transition resulting in a shape where said at least one attachment means releases the attachment between the parts.

2. A method according to claim 1, further comprising
cooling down said parts in order to adjust the temperature of said MSM element to a predetermined temperature range prior to said step of exposing said at least one attachment means to a magnetic field.

3. A method according to claim 1, further comrising:
arranging said parts attached to each other onto a conveyor; and
transporting said parts on the conveyor through a gap where the magnetic field has been generated, whereby said at least one attachment means is exposed to the magnetic field.

4. A method according to claim 3, wherein
arranging said parts onto the conveyor comprises arranging said parts onto the conveyor in a predetermined position such that said at least one attachment means will be exposed to the magnetic field from a predetermined direction.

5. A method according to claim 1, further comprising
generating said magnetic field with one or more permanent magnets.

6. A method according to claim 1, further comprising
generating said magnetic field with one or more electromagnets.

7. A method of handling parts of a product, comprising:
providing said parts with at least one attachment means comprising a Magnetic Shape Memory (MSM) element, which is shaped to allow said at least one attachment means to attach the parts to each other;
attaching said parts to each other with said at least one attachment means; and in order to disassemble said product,
exposing said at least one attachment means to a magnetic field, which triggers a shape transition of said MSM element resulting in a shape where said at least one attachment means releases the attachment between the parts.

8. A method according to claim 7, further comprising
cooling down said parts in order to adjust the temperature of said MSM element to a predetermined temperature range prior to exposing said at least one attachment means to the magnetic field.

9. A method according to claim 7, wherein said exposing of said at least one attachment means to the magnetic field is carried out by transporting said parts through a magnetic field generated by one or more permanent magnets.

10. A method according to claim 7, wherein said exposing of said at least one attachment means to the magnetic field is carried out by transporting said parts through a magnetic field generated by one or more electromagnets.

11. A product comprising at least two parts attached to each other by at least one attachment means, wherein
said at least one attachment means includes an element made of a Magnetic Shape Memory (MSM) material, which is shaped in a first shape allowing said at least one attachment means to attach said parts to each other, and which is responsive to a magnetic field for entering a shape transition resulting in a second shape, whereby the attachment between said parts achieved by said at least one attachment means is released.

12. A product according to claim 11, wherein
said element is made of an MSM material which is responsive to a magnetic field for entering a shape transition, provided that the temperature of the material is within a predetermined temperature range substantially below ordinary room temperature.

13. A product according to claim 10, wherein said product is a portable communication terminal.

14. A product according to claim 11, wherein the material of said MSM element consists of NiMnGa alloy.

15. A method according to claim 2, further comrising:
arranging said parts attached to each other onto a conveyor; and
transporting said parts on the conveyor through a gap where the magnetic field has been generated, whereby said at least one attachment means is exposed to the magnetic field.

16. A method according to claim 2, further comprising generating said magnetic field with one or more permanent magnets.

17. A method according to claim 3, further comprising generating said magnetic field with one or more permanent magnets.

18. A method according to claim 4, further comprising generating said magnetic field with one or more permanent magnets.

19. A method according to claim 2, further comprising generating said magnetic field with one or more electromagnets.

20. A method according to claim 3, further comprising generating said magnetic field with one or more electromagnets.

21. A method according to claim 4, further comprising generating said magnetic field with one or more electromagnets.

22. A method according to claim 8, wherein said exposing of said at least one attachment means to the magnetic field is carried out by transporting said parts through a magnetic field generated by one or more permanent magnets.

23. A method according to claim 8, wherein said exposing of said at least one attachment means to the magnetic field is carried out by transporting said parts through a magnetic field generated by one or more electromagnets.

24. A product according to claim 11, wherein said product is a portable communication terminal.

25. A product according to claim 12, wherein the material of said MSM element consists of NiMnGa alloy.

26. A product according to claim 13, wherein the material of said MSM element consists of NiMnGa alloy.
